(19) United States
(12) Patent Application Publication
(10) Pub. No.: US 2004/0051471 A1
(43) Pub. Date: Mar. 18, 2004

(54) Reborn circuit of a light string

(76) Inventor: Chun-Chang Yen, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/227,825

(22) Filed: Aug. 27, 2002

(51) Int. Cl. H05B 37/00

(52) U.S. Cl. 315/185 S; 315/185 R; 315/56

(57) ABSTRACT

The present invention relates to a reborn circuit of a light string, which includes an electrical wire connecting with several bulbs and a plug to complete an electrical circuit, wherein the plug is inside provided with a detector connecting with a high-voltage controller and a switch on the electrical circuit. The detector can detect an abnormal signal that one bulb is broken, and to start the controller and to change the switch contacting with the controller. So a new electrical circuit with high voltage is formed between the two conductive wires of the broken bulb, that breaks out the oxide layer at contact position of the aluminous wire to obtain a completed circuit for the circuit of the light string to be reborn.

### BACKGROUND OF THE INVENTION

A conventional light string includes an electrical wire to connect with several bulb assemblies. A plug is provided at one end of the light string for connecting to a power source and to lighten the bulb. Most bulb assemblies are connected together in series. If one bulb is broken, the electrical circuit is cut that makes the light string out of work. It is known that an aluminous wire (12) being parallel to a tungsten fillet (13) is provided around two conductive wires (11) in the bulb (1), as shown in FIG. 3. But the known aluminous wire (12) is often oxidized and a oxide layer (121) is formed that separates the wire (12) from the conductive wires (11) while the electrical current can not pass through and the circuit is still cut.

Accordingly, the primary object of the invention is to provide a reborn circuit of a light string, which includes a detector to detect the electrical current for change a switch on the circuit and a high-voltage controller to reborn the electrical circuit of the light string. Now the features and advantages of the present invention will be described in detail with reference to the accompanying drawings.

### BRIEF DESCRIPTION OF ACCOMPANYING DRAWINGS

FIG. 1 is a plan view showing a normal circuit of a light string according to the present invention.

FIG. 2 is a plan view showing the light string of FIG. 1 when the circuit is reborn.

FIG. 3 is a perspective view showing a bulb.

FIG. 4 is a cross-sectional plan view of FIG. 3 showing two conductive wires with an aluminous wire.

FIG. 5 shows the reborn structure of FIG. 4.

### DETAILED DESCRIPTION OF PREFERRED EMBODIMENTS

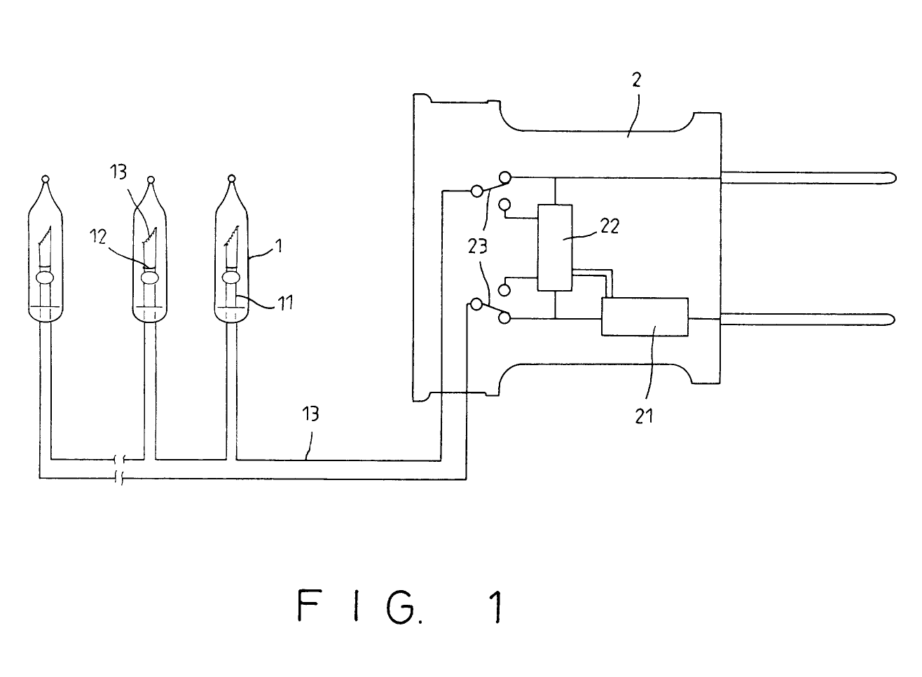

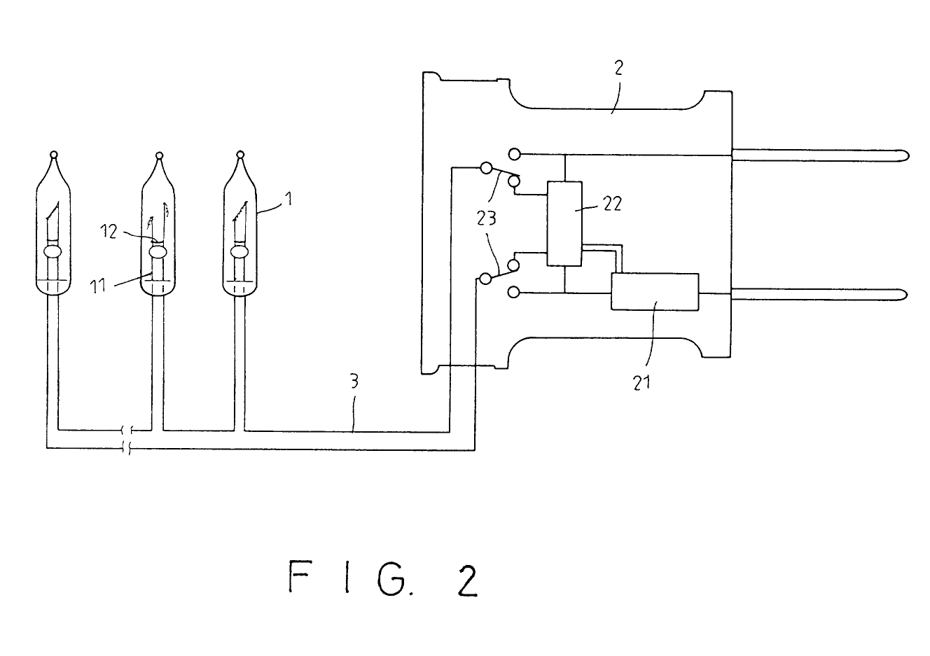

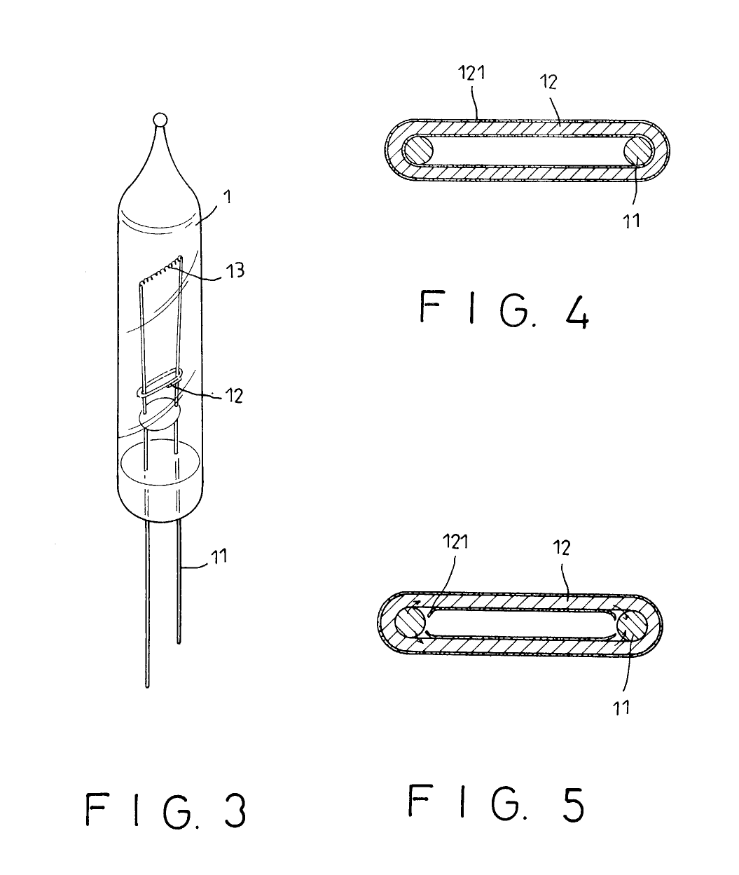

Please refer to FIG. 1 firstly, the present invention includes an electrical wire (3) connecting with several bulbs (1) and a plug (2) to complete an electrical circuit. The plug (2) is inside provided with a detector (21) connecting with a high-voltage controller (22) and a switch (23) on the electrical circuit. As one bulb (1) is broken, as shown in FIG. 2, wherein a tungsten fillet (13) is cut and the electrical current is cut neither. As soon as the detector (21) detects this abnormal signal, it starts the controller (22) and turns the switch (23) to contact with the controller (22) at the same time. Meanwhile, a new electrical circuit with high voltage is formed. This high voltage occurs between the conductive wires (11) of the broken bulb (1) and it can break out the oxide layer (121) at contact position of the aluminous wire (12), as shown in FIGS. 4 and 5. While the circuit of the light string is reborn, the switch (23) is turned back and the high-voltage controller (22) is stopped. The light string is reborn except the broken bulb.

Accordingly, the present invention obviously achieves utility and improvement and should be allowed for patent.

What is claimed is:

1. A reborn circuit of a light string including an electrical wire connecting with several bulbs and a plug to complete an electrical circuit, wherein the plug is inside provided with a detector connecting with a high-voltage controller and a switch on the electrical circuit.

2. A reborn circuit of a light string as claimed in claim 1, wherein the detector can detect an abnormal signal that one bulb is broken, and to start the controller and to change the switch contacting with the controller, while a new electrical circuit with high voltage is formed between the two conductive wires of the broken bulb, that breaks out the oxide layer at contact position of the aluminous wire to obtain a completed circuit for the circuit of the light string to be reborn.
